(19) United States
(12) Patent Application Publication
(10) Pub. No.: US 2010/0321168 A1
(43) Pub. Date: Dec. 23, 2010

(54) POWER LINE COMMUNICATION DEVICE AND ITS COMMUNICATION CONTROL METHOD

(76) Inventor: Hiroki SUGAWARA, Tokyo (JP)

Correspondence Address: BLACK LOWE & GRAHAM, PLLC, 701 FIFTH AVENUE, SUITE 4800, SEATTLE, WA, 98104, US

(21) Appl. No.: 12/521,495

(22) PCT Filed: Nov. 30, 2007
(86) PCT No.: PCT/JP2007/073147

§ 371 Date: Dec. 17, 2009

(30) Foreign Application Priority Data
Dec. 28, 2006 (JP) 2006-355122

(51) Int. Cl. G05B 11/01

(52) U.S. Cl. 340/310.11

(57) ABSTRACT

In a case where to-be-transmitted data is absent, signal output from a PLC apparatus is topped. A PLC modem includes a PLC-IF, and a modem control unit. The modem control unit effects transition to a hibernate state in which signal output from the PLC-IF is stopped, in accordance with a fact that a state in which transmission data that is transmitted to the PLC-IF and reception data that is received via the PLC-IF are absent continues over a predetermined hibernation determination period. In addition, the modem control unit effects transition to a normal working state in which the signal output from the PLC-IF is executed, in accordance with a fact that in the hibernate state an amount of to-be-transmitted data to the PLC-IF has exceeded a predetermined startup threshold or reception of a startup signal by the PLC-IF has been detected.

### CROSS REFERENCE TO RELATED APPLICATIONS

This is a Continuation Application of PCT Application No. PCT/JP2007/073147, filed Nov. 30, 2007, which was published under PCT Article 21(2) in Japanese.

This application is based upon and claims the benefit of priority from prior Japanese Patent Application No. 2006-355122, filed Dec. 28, 2006, the entire contents of which are incorporated herein by reference.

### BACKGROUND OF THE INVENTION

1. Field of the Invention

The present invention relates to a technique of reducing a leak electric field in power line communication (PLC).

2. Description of the Related Art

PLC is a technique of performing data communication by superimposing a carrier wave on a power line (distribution line) which is laid, for example, within a building in order to supply AC power. In recent years, practical use has promoted of high-speed PLC which enables high-speed data communication by utilizing a high frequency band of 2 M to 30 MHz. However, the frequency band of 2 M to 30 MHz has been used by many existing radio systems, such as nautical/aeronautical radio systems and amateur radio systems. Thus, there has been a strong demand for a decrease in leak electric field in practical use of high-speed PLC so that a leak electric field, which is radiated from a power line by high-speed PLC, may not adversely affect existing radio systems, and there have been proposed various countermeasure techniques for reducing the leak electric field intensity.

Examples of the countermeasure technique for reducing the leak electric field intensity include reduction in transmission power by adopting spread spectrum or OFDM (Orthogonal Frequency Division Multiplexing) in a digital modulation system, dynamic control of transmission power, improvement of modem balancing, and suppression of common mode current by choke coil insertion. Patent document 1 discloses a PLC modem which executes transmission power control in accordance with a detection result of leak power. Specifically, the PLC modem disclosed in patent document 1 adopts OFDM for a transmission data modulation method. This PLC modem detects leak power from a power line, and controls the transmission power of each sub-carrier so as to lower the transmission power of a sub-carrier with a large leak power.

Although not relating to the reduction in leak electric field in PLC, patent document 2 discloses an xDSL system which comprises an xDSL (Digital Subscriber Line) modem which is installed in a central office, and an xDSL user modem which is installed in a user home and is connected to the xDSL modem over a telephone line. An xDSL modem generates a wakeup signal and sends it to the xDSL modem in the central office. The xDSL modem, which has received the wakeup signal, is switched from a low-power-consumption sleep mode to a working mode for data transfer, and executes data transfer with the xDSL user modem after starting a predetermined startup procedure. In addition, as a concrete example of transmission timing of a wakeup signal by the xDSL user modem, there is disclosed periodical transmission of the wakeup signal by the xDSL user modem.

Furthermore, although not relating to the reduction in leak electric field in PLC, patent document 3 discloses a network system using PLC. The network system of patent document 3 includes a server and a plurality of terminals, and these are connected over a power line and are communicable by PLC. Data transfer between the plural terminals is executed via the server. In addition, the terminal transitions to a sleep mode in a case where there is no process to be executed. The terminal, which is in the sleep mode, transitions to a normal mode in response to an input of a transmission request, and transmits a packet to the server. The server, which has received the packet, transfers the packet to the terminal that is the counterpart of communication, and waits for a confirmation response from the terminal that is the counterpart of communication. In a case where the confirmation response is not received, the server holds the packet in a packet queue for the terminal that is the counterpart of communication. On the other hand, the terminal, which is in the sleep mode, restores to the normal mode in response to the passage of a predetermined time, and transmits an inquiry packet to the server. The server, which has received the inquiry packet, sends the condition of the packet queue (the amount of data that is held) to the terminal that is the origin of inquiry. The terminal, which has received the report of the condition of the packet queue, sends to the server a request for data readout from the packet queue. Responding to the readout request, the server sends to the terminal the data that is accumulated in the packet queue. In short, the server functions as a data relay between the terminals, and temporarily accumulates packets in the case where the terminal is in the sleep mode. The terminal transitions to the sleep mode in the case where there is no process to be executed, and periodically restores to the normal mode and sends to the server an inquiry as to whether there is data that is to be received. By this structure, the power consumption of the PLC network can be reduced.

Patent document 1: Jpn. Pat. Appln. KOKAI Publication No. 2006-186733;

Patent document 2: Jpn. PCT National Publication No. 2004-518387; and

Patent document 3: Jpn. Pat. Appln. KOKAI Publication No. 2005-72970.

### BRIEF SUMMARY OF THE INVENTION

### Problem to be Solved

The inventor of the present invention has found a problem that in a PLC apparatus, such as a PLC modem, which is connected to a power line and performs data transmission by PLC, the average intensity of a leak electric field from the power line is large since a carrier wave of a high frequency band is output to the power line, despite there being no data to be transmitted.

In the network system disclosed in the above-described patent document 3, it is necessary to provide a server apparatus which has to operate at all times. In addition, the terminal needs to periodically restore to the normal mode from the sleep mode, and to send an inquiry to the server. Specifically, it is difficult to sufficiently reduce the average intensity of a leak electric field, owing to the occurrence of transmission of an unnecessary packet from the server to the terminal which is in the sleep mode, owing to the occurrence of transmission of an inquiry packet from the terminal to the server, and owing to the occurrence of transmission of a packet for reporting the condition of the packet queue from the server to the terminal.

The present invention has been made in consideration of the above-described circumstance, and the object of the invention is to provide a PLC apparatus and a communication control method thereof, which can reduce the average intensity of a leak electric field from a power line, by stopping signal output from the PLC apparatus in a case where there is no data that is to be transmitted.

### Means for Solving the Problem

A power line communication apparatus according to a first aspect of the present invention includes a PLC interface which is connected to a power line, and a control unit which controls signal output by the PLC interface. The control unit effects transition to a hibernate state in which the signal output from the PLC interface is stopped, in accordance with a fact that a state in which transmission data that is transmitted to the PLC interface and reception data that is received via the PLC interface are absent continues over a predetermined hibernation determination period, and the control unit effects transition to a normal working state in which the signal output from the PLC interface is executed, in accordance with a fact that in the hibernate state an amount of to-be-transmitted data to the PLC interface has exceeded a predetermined startup threshold or reception of a startup signal by the PLC interface has been detected, and the control unit causes the PLC interface to output the startup signal in a case where transition is effected to the normal working state in accordance with the exceeding of the startup threshold. For example, a hibernation determination unit 14, a startup determination unit 15 and a modem control unit 16 in an embodiment 1 of the present invention, which will be described later, correspond to the control unit which is included in the power line communication apparatus according to the first aspect.

In the power line communication apparatus according to the first aspect having the above-described structure, in the case where there is no data that is to be transmitted/received, the high-frequency signal output to the power line is stopped. Thus, the average intensity of the leak electric field from the power line can be reduced. In addition, the power line communication apparatus according to the first aspect is configured to be able to restore from the hibernate state to the normal working state by receiving the startup signal from the communication counterpart apparatus. Therefore, it is possible to suppress the output of an unnecessary signal to the power line due to the periodical restoration to the normal working state.

Moreover, the power line communication apparatus according to the first aspect restores from the hibernate state to the normal working state, in response to the fact that the amount of to-be-transmitted data has exceeded the predetermined startup threshold. In other words, there is no need to immediately restore to the normal working state each time transmission data occurs. Therefore, it is possible to suppress the occurrence of such a situation that the average intensity of the leak electric field cannot sufficiently be reduced owing to frequent restoration to the normal working state and a decrease in the time of the hibernate state.

The startup signal may be configured to include ID information which is capable of uniquely identifying a communication counterpart apparatus, and the control unit may be configured to detect the reception of the startup signal by the PLC interface, on the basis of a collation result between the identification information and collation information for identifying own apparatus. According to this startup signal, in the case where a plurality of power line communication apparatuses are connected to the power line and the plural power line communication apparatuses are in the hibernate state, only the specified power line communication apparatus that needs to be started up as the communication counterpart can be started up.

The control unit may be configured to effect transition from the hibernate state to the normal working state in accordance with a startup instruction which is input from outside, and to cause the PLC interface to output the startup signal.

The startup instruction, which is input from outside, may be configured to include apparatus designation information which designates the communication counterpart apparatus, and the control unit may cause the PLC interface to output the startup signal including the ID information which is determined on the basis of the apparatus designation information. Thereby, in the case where a plurality of power line communication apparatuses are connected to the power line and the plural power line communication apparatuses are in the hibernate state, only the specified power line communication apparatus that needs to be started up as the communication counterpart can be started up in accordance with the user's intention.

The power line communication apparatus according to the first aspect may further includes a LAN interface, and a transmission data buffer which stores the transmission data which is relayed between the LAN interface and the PLC interface, and the control unit may determine transition from the hibernate state to the normal working state by comparing an amount of data stored in the transmission data buffer and the startup threshold. By this structure, the amount of to-be-transmitted data can easily be understood.

The control unit may be configured to execute determination of the absence of the transmission data and the reception data, by referring to a transmission/reception history of the LAN interface. By this structure, the condition of use of the PLC interface can easily be understood.

A control method of a power line communication apparatus according to a second aspect of the present invention includes monitoring presence/absence of transmission data which is transmitted to a PLC interface that is connected to a power line and reception data which is received via the PLC interface; and effecting transition to a hibernate state in which signal output from the PLC interface is stopped, in accordance with a fact that a state in which the transmission data and the reception data are absent continues over a predetermined hibernation determination period. The control method further includes effecting transition to a normal working state in which the signal output from the PLC interface is executed, in accordance with a fact that in the hibernate state an amount of to-be-transmitted data to the PLC interface has exceeded a predetermined startup threshold or reception of a startup signal by the PLC interface has been detected; and causing the PLC interface to output the startup signal in a case where transition is effected to the normal working state in accordance with the exceeding of the startup threshold.

According to the control method relating to the second aspect, in the case where there is no data that is to be transmitted/received, the high-frequency signal output to the power line is stopped. Thus, the average intensity of the leak electric field from the power line can be reduced. In addition, according to the method of the second aspect, the power line communication apparatus is controlled to restore from the hibernate state to the normal working state by receiving the startup signal from the communication counterpart apparatus. Therefore, it is possible to suppress the output of an unnecessary signal to the power line due to the periodical restoration to the normal working state. Moreover, according to the method of the second aspect, the power line communication apparatus is controlled to restore from the hibernate state to the normal working state, in response to the fact that the amount of to-be-transmitted data has exceeded the predetermined startup threshold. In other words, there is no need to immediately restore to the normal working state each time transmission data occurs. Therefore, it is possible to suppress the occurrence of such a situation that the average intensity of the leak electric field cannot sufficiently be reduced owing to frequent restoration to the normal working state and a decrease in the time of the hibernate state.

### ADVANTAGEOUS EFFECT OF THE INVENTION

The present invention can provide a PLC apparatus and a communication control method thereof, which can reduce the average intensity of a leak electric field from a power line, by stopping signal output from the PLC apparatus in a case where there is no data that is to be transmitted.

### BRIEF DESCRIPTION OF THE SEVERAL VIEWS OF THE DRAWING

FIG. 1 shows the structure of a PLC communication system according to an embodiment of the present invention;

FIG. 2 shows the structure of a PLC modem according to the embodiment of the invention;

FIG. 3 shows a state transition of the PLC modem according to the embodiment of the invention;

FIG. 4 is a flow chart illustrating a process at a time when the PLC modem according to the embodiment of the invention transitions to a hibernate state;

FIG. 5 is a flow chart illustrating a process at a time when the PLC modem according to the embodiment of the invention transitions to a normal working state;

FIG. 6 is a flow chart illustrating a process at a time when the PLC modem according to the embodiment of the invention transitions to a normal working state; and

FIG. 7 is a flow chart illustrating a process at a time when the PLC modem according to the embodiment of the invention transitions to a normal working state.

### DESCRIPTION OF REFERENCE NUMERALS

100 . . . PLC communication system
1 . . . patent modem
2 . . . child modem
3 . . . power line
10, 20 . . . PLC interface (PCL-IF)
11, 21 . . . LAN interface (LAN-IF)
12 . . . transmission data buffer
13 . . . reception data buffer
14 . . . hibernation determination unit
15 . . . startup determination unit
16 . . . modem control unit.

### DETAILED DESCRIPTION OF THE INVENTION

Specific embodiments, to which the present invention is applied, will now be described in detail with reference to the accompanying drawings. In each of the drawings, the same elements are denoted by like reference numerals, and an overlapping description is omitted, where necessary, in order to clarify the description.

### Embodiment 1 of the Invention

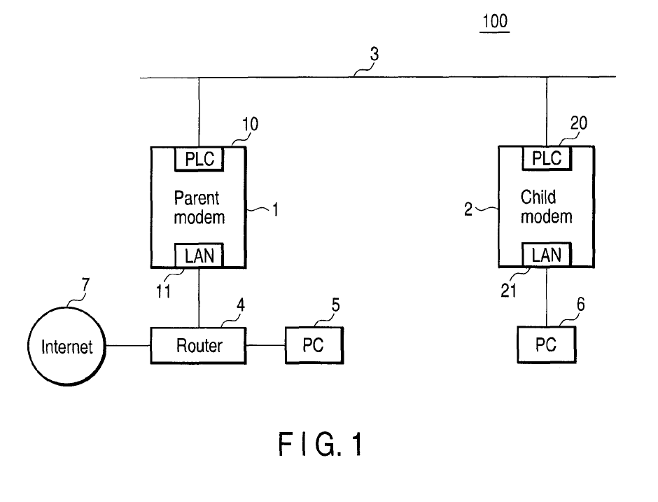

FIG. 1 shows a PLC communication system according to an embodiment of the present invention. The PLC communication system 100 shown in FIG. 1 includes a parent modem 1 and a child modem 2, which are connected over a power line 3. The parent modem 1 includes a PLC interface 10 which is connected to the power line 3, and a LAN interface 11, and executes data relay between the PLC interface 10 and LAN interface 11. Similarly, the child modem 2 executes data relay between a PLC interface 20 which is connected to the power line 3, and a LAN interface 21.

FIG. 1 shows, by way of example, such a structure that a router 4 is connected to the LAN interface 11 of the parent modem 1, and a PC (Personal Computer) 6 is connected to the LAN interface 21 of the child modem 2. By this structure, data, which is output from the PC 6, is relayed via the power line 3 to the router 4, PC 5 or the Internet 7. The same applies to the reverse direction.

The parent modem 1 and child modem 2 according to the present embodiment can stop signal output from the PLC interfaces 10 and 20. Further, the parent modem 1 and child modem 2 are characterized by conditions for restoration from a hibernate state, in which signal output is stopped, to a normal working state in which signal output is enabled. A detailed description is given of the structures and operations of the parent modem 1 and child modem 2, which can transition between the normal working state and hibernate state.

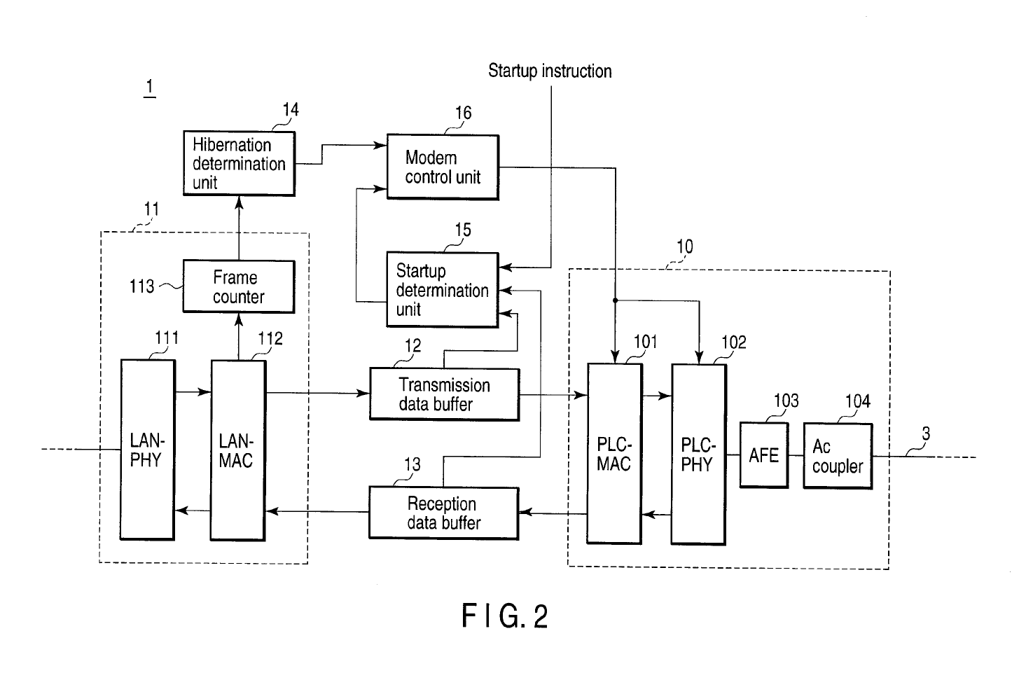

FIG. 2 is a block diagram showing the structure of the parent modem 1. Since the child modem 2 has the same structure as the parent modem 1, a detailed description of the structure of the child modem 2 is omitted. In FIG. 2, the PLC interface 10 includes a PLC-MAC unit 101, a PLC-PHY unit 102, an analog front end (APE) 103, and an AC coupler 104. The PLC-MAC unit 101 executes assembly/decomposition of a data frame according to the PLC interface, encryption/decryption of data, and data transmission control between itself and the child modem 2. The PLC-PHY unit 102 executes digital modulation/demodulation such as OFDM or spread spectrum. The AFE 103 is a circuit which transmits/receives an analog signal of 2 M to 30 MHz of a digitally modulated signal, and includes a D/A converter, a driver circuit and a receiver circuit. The AC coupler 104 is a circuit which superimposes an analog signal of PLC on the power line 3.

The LAN interface 11 includes a LAN-PHY unit 111, a LAN-MAC unit 112 and a frame counter 113. The LAN-PHY unit 112 performs a process of a physical layer corresponding to wired LAN such as 100BASE-TX or wireless LAN such as IEEE802.11b. The LAN-MAC unit 112 executes assembly/disassembly of a MAC frame which is transmitted/received between itself and the LAN-PHY unit 111, and data transmission control with devices (e.g. router 4 and PC 6) which are connected via the LAN interface. The frame counter 113 is a counter which measures the number of MAC frames which are transmitted/received in the LAN interface 11.

A transmission data buffer 12 is a memory which stores transmission data that is relayed from the LAN interface 11 to the PLC interface 10. On the other hand, a reception data buffer 13 is a memory which stores reception data that is relayed from the PLC interface 10 to the LAN interface 11.

A hibernation determination unit 14 monitors the presence/absence of transmission/reception data of the LAN interface 11 by referring to the frame counter 103. Further, if data transmission/reception is not executed over a preset hibernation determination period, the hibernation determination unit 14 informs a modem control unit 16 of the passage of the hibernation determination period.

A startup determination unit 15 is a process unit which determines a transition condition for transition from the hibernate state to the normal working state. Specifically, the startup determination unit 15 in the present embodiment outputs to the modem control unit 16 a report prompting transition to the normal working state in a case where any one of the three transition conditions, which are to be described below, is satisfied.

The first transition condition is that the amount of to-be-transmitted data, which is to be transmitted from the PLC interface 10, has exceeded a predetermined threshold (hereinafter referred to as “startup threshold”). The determination of the first transition condition may be executed by monitoring the amount of data stored in the transmission data buffer 12.

The second transition condition is that a startup signal has been received via the PLC interface from the communication counterpart modem, namely the child modem 2 in this embodiment. The determination of the second transition condition may be executed by monitoring data which is stored in the reception data buffer 13, comparing the received data with prestored startup signal data that is indicative of the startup signal, and detecting the reception of the startup signal by the agreement between the received data and the startup signal data.

The third transition condition is that a startup instruction has been input from the outside by the user. The input of the startup instruction by the user may be executed, for example, by detecting an input on an operation button (not shown) which is provided on a housing (not shown) of the parent modem 1. In addition, the input of a startup instruction command may be accepted via the LAN interface 11. Specifically, data which is received by the LAN interface 11 is compared with prestored startup instruction data that is indicative of a startup instruction, and the input of the startup instruction may be detected by the agreement between the received data and the startup instruction data.

The determination on the basis of the above-described first to third transition conditions may be executed only in the case where the parent modem 1 is in the hibernate state. In other words, in the case where the parent modem 1 is in the normal working state, the startup determination unit 15 does not need to execute the monitoring of the transmission data amount, the detection of the startup signal reception, or the detection of the startup instruction input.

Referring back to FIG. 2, a further description is given. The modem control unit 16 is a processor which executes an overall control of the parent modem 1 including an output stop control of the PLC interface 10. If the modem control unit 16 receives a report corresponding to the passage of the hibernation determination period from the hibernation determination unit 14, the modem control unit 16 stops signal output to the power line 3 by the PLC interface 10.

For example, in the case where OFDM is adopted for the PLC-PHY layer of the parent modem 1 and the connection negotiation between the parent modem 1 and child modem 2 is performed by successively executing four phases, namely a line survey phase (00) in which characteristics of the power line 3 are inspected, a tone mapping phase (01) in which a usable sub-band is selected, a bit mapping phase (02) in which bits are allocated to a usable sub-band and a transmission phase (03) in which data transmission/reception is executed, it should suffice if the output of the PLC interface 10 is stopped by the procedure that is to be described below. To begin with, a connection reset signal for causing the connection negotiation to be re-executed and a pose signal for maintaining the line survey phase (00) and prohibiting the transition to the tone mapping phase (01) may be output from the control unit 16 to the PLC interface 10.

If the modem control unit 16 receives from the startup determination unit 15 a report that any one of the above-described first to third transition conditions has been satisfied, the modem control unit 16 resumes the signal output to the power line 3 by the PLC interface 10. In the above-described example, a connection reset signal for re-executing the connection negotiation is output once again to the PLC interface 10 from the modem control unit 16.

Further, in the case of restoring to the normal working state by the above-described first or third transition condition, the modem control unit 16 instructs the PLC interface 10 to output the startup signal to the communication counterpart PLC apparatus (child modem 2).

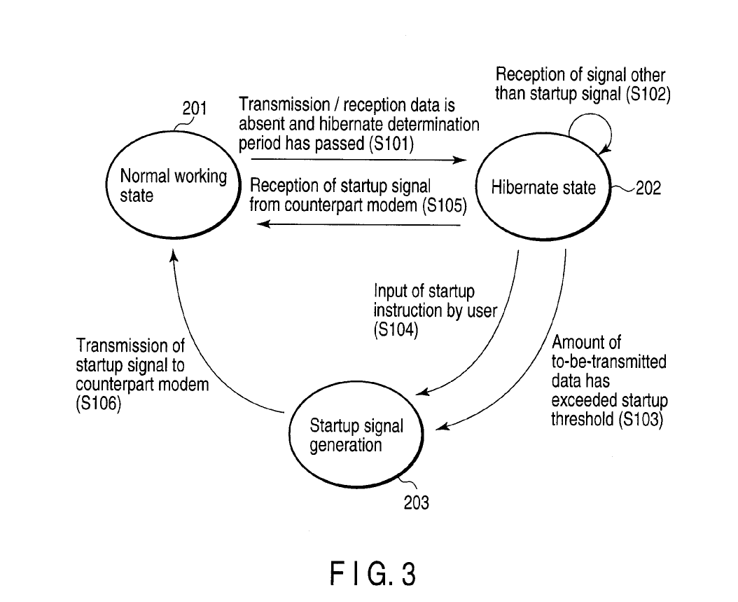

A state transition diagram of FIG. 3 shows the state transition between the states including the normal working state and hibernate state of the parent modem 1 having the above-described structure shown in FIG. 2. In FIG. 3, a normal working state 201 is a state in which signal output to the power line 3 from the PLC interface 10 is permitted and data transmission/reception with the child modem 2 is enabled. A hibernate state 202 is a state in which signal output to the power line 3 from the PLC interface 10 is prohibited. The transition from the normal operation state 201 to the hibernate state 202 is executed in the case where the state in which transmission data that is transmitted to the PLC interface 10 and reception data that is received via the PLC interface 10 are absent continues over the hibernation determination period (S101).

At the time of the hibernate state 202, the parent modem 1 remains in the hibernate state 201 even if the parent modem 1 receives a signal, other than a startup signal, from the PLC interface 10 (S102). On the other hand, in the case where at the time of the hibernate state 202 the amount of to-be-transmitted data, which is stored in the transmission data buffer 12, exceeds a startup threshold or a startup instruction is input by the user, transition occurs to a startup signal generation state 203 (S103, 104). In the startup signal generation state 203, after a startup signal is transmitted to the child modem 3 that is the communication counterpart, transition occurs to the normal working state (S106). In addition, in the case where at the time of she hibernate state 202 a startup signal is received from the child modem 2 that is the communication counterpart, transition occurs from the hibernate state 202 to the normal working state 201 (S105).

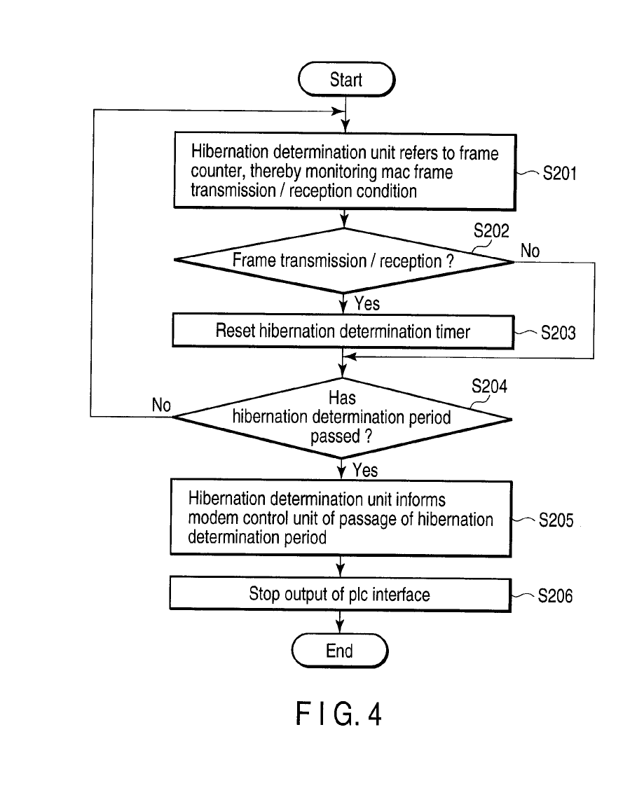

The transition (S101) from the normal working state 201 to the hibernate state 202 in FIG. 3 is executed by a process procedure illustrated in FIG. 4. To start with, in step S201, the hibernation determination unit 14 refers to the frame counter 103, thereby monitoring the transmission/reception condition of the MAC frame of the LAN interface 11. At this time, if the transmission or reception of the MAC frame is being executed, a timer (not shown) for hibernation determination is reset (steps S202 and S203). In step S204, the passage of the hibernation determination period is determined. Specifically, if the timer (not shown) for hibernation determination has not passed the hibernation determination period, the procedure returns to step S201. On the other hand, if transmission or reception of the MAC frame is not executed and the hibernation determination period has passed, the hibernation determination unit 14 informs the modem control unit 16 of the passage of the hibernation determination period (step S205). In accordance with the information from the hibernation determination unit 14, the modem control unit 16 stops the signal output to the power line 3 from the PLC interface 10 (step S206).

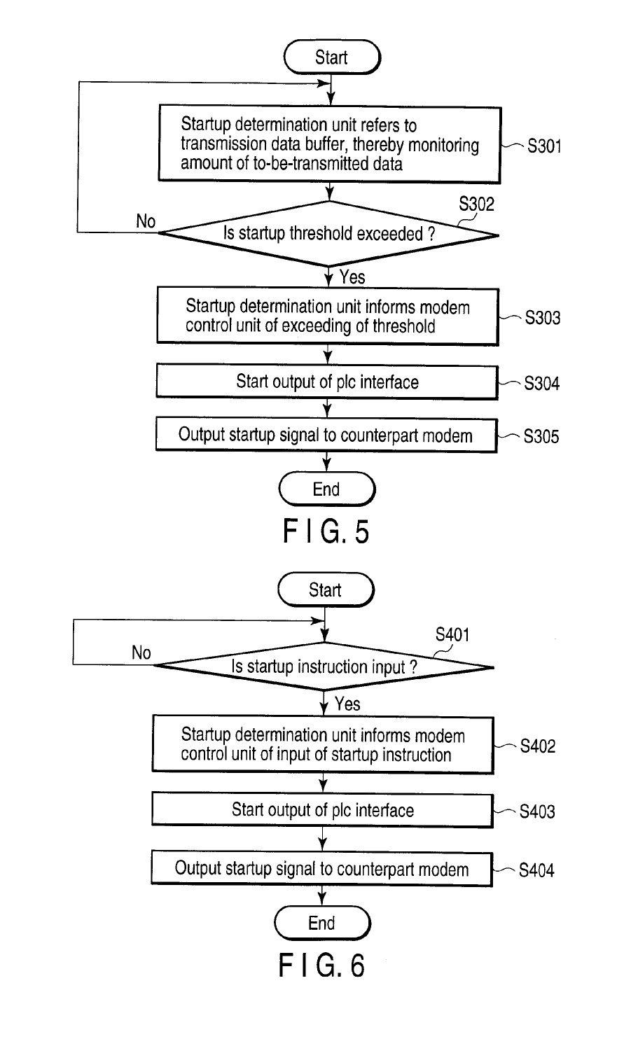

The transition (S103) from the hibernate state 202 to the startup signal generation state 203 in FIG. 3 and the transition (S106) from the startup signal generation state 203 to the normal working state 201 are executed by a process procedure illustrated in FIG. 5. In step S301, the startup determination unit 15 refers to the transmission data buffer 12, thereby monitoring the amount of to-be-transmitted data. In step S302, it is determined whether the amount of to-be-transmitted data has exceeded a startup threshold. If the amount of to-be-transmitted data has not exceeded the startup threshold, the procedure returns to step S301. On the other hand, if the amount of to-be-transmitted data has exceeded the startup threshold, the modem control unit 16, upon receiving information from the startup determination unit 15, resumes the signal output to the power line 3 from the PLC interface 10 (steps S303 and S304). Further, the modem control unit 16 causes the PLC interface 10 to output the startup signal to the child modem 2 that is the communication counterpart (step S305).

The transition (S104) from the hibernate state 202 to the startup signal generation state 203 in FIG. 3 and the transition (S106) from the startup signal generation state 203 to the normal working state 201 are executed by a process procedure illustrated in FIG. 6. In step S401, it is determined whether a startup instruction by the user has been input. If the startup instruction has not been input, step S401 is repeated. On the other hand, the process of steps S402 to 5404 in the case where the input of the startup instruction has been detected is the same as the above-described process of steps S303 to 5305 in FIG. 5.

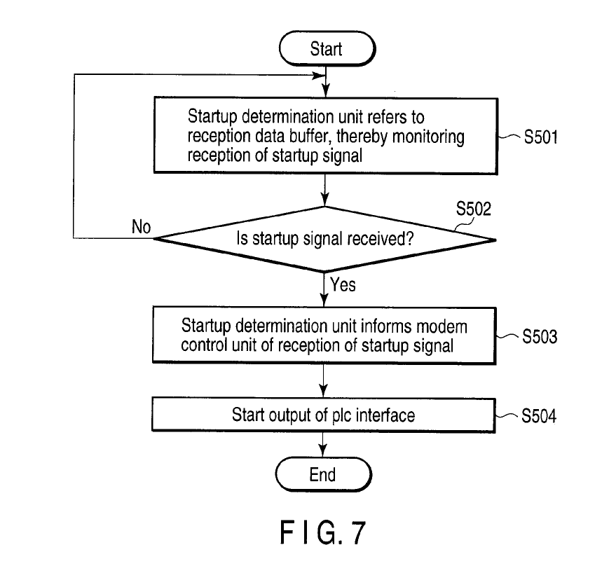

The transition (S105) from the hibernation state 202 to the normal working state 201 in FIG. 3 is executed by a process procedure illustrated in FIG. 7. In step S501, the startup determination unit 15 refers to the reception data buffer 13, thereby monitoring the reception of the startup signal. In step S502, it is determined, on the basis of the reception data, whether the startup signal has been detected. If the startup signal has not been detected, the procedure returns to step S501. On the other hand, if the startup signal has been detected from the data that is received from the PLC interface 10, the modem control unit 16 resumes the signal output to the power line 3 from the PLC interface 10 in accordance with information from the startup determination unit 15 (steps S503 and S504).

As has been described above, in the parent modem 1 and child modem 2 according to the present embodiment, in the case where there is no data that is to be transmitted/received, the output of the carrier wave of the high frequency band to the power line 3 is stopped. Thus, the average intensity of the leak electric field from the power line 3 can be reduced. In addition, the parent modem 1 and child modem 2 according to the present embodiment are configured to be able to restore from the hibernate state to the normal working state by receiving the startup signal from the communication counterpart apparatus. Thus, unlike the apparatus disclosed in patent document 3, there is no need to periodically restore from the hibernate state to the normal working state. Therefore, it is possible to suppress the output of an unnecessary signal to the power line 3 due to the periodical restoration to the normal working state.

Moreover, the parent modem 1 and child modem 2 according to the present embodiment restore from the hibernate state to the normal working state, in response to the fact that the amount of to-be-transmitted data has exceeded the predetermined startup threshold. In other words, there is no need to immediately restore to the normal working state each time transmission data occurs. Therefore, it is possible to suppress the occurrence of such a situation that the average intensity of the leak electric field cannot sufficiently be reduced owing to frequent restoration to the normal working state and a decrease in the time of the hibernate state.

In the parent modem 1 and child modem 2 according to the present embodiment, the startup signal is not a simple pulse signal cr the like. By collation with the prestored startup signal data, the startup signal, which is input to the PLC interface 10 via the power line 3, is discriminated. Therefore, the startup signal is not erroneously recognized by noise or a signal that is output from other devices having different communication systems, which are connected to the power line 3.

### Other Embodiments

In the above-described embodiment 1 of the invention, two PLC modems (parent modem 1 and child modem 2) are connected to the power line 3. In the embodiment of the invention, however, the PLC communication system may include three or more PLC modems. In this case, the startup signal, which is transmitted to the communication counterpart PLC modem, may be configured to include identification information, for example, a MAC address, by which the PLC modem that is to be started up can be identified. Specifically, when the communication counterpart PLC modem is to be started up in accordance with a startup instruction from the user, the selection of the PLC modem to be started is also accepted, the MAC address of the selected PLC modem is acquired, and the acquired MAC address may be included in the startup signal. According to this startup signal, in the case where a plurality of PLC modems are connected to the power line 3 and the plural modems are in the hibernate state, only the specified PLC modem that needs to be started up as the communication counterpart can be started up.

Furthermore, when the communication counterpart PLC modem is to be started up in accordance with the startup instruction that is input by the user, the PLC modems (parent modem 1 and child modem 2) may accept, from the user, the input of startup signal data corresponding to the communication counterpart. For example, by accepting the input of text data by the user, the text data can be transmitted as the startup signal data. By this structure, in accordance with the user's intention, the specified PLC modem that needs to be started up as the communication counterpart can selectively be started up.

In the above-described embodiment 1 of the invention, the invention is applied to the PLC modem. However, the embodiment of the invention is not limited to the PLC modem. The invention is also applicable to PLC apparatuses which are configured such that PLC interfaces are directly built in electrical household apparatuses or vide apparatuses, and data, which is generated from process units of these apparatuses, which execute processes of upper-level layers, can directly output from the PLC interfaces.

The present invention is not limited to the above-described embodiments. Needless to say, various modifications may be made without departing from the spirit of the invention.

What is claimed is:

1. A power line communication apparatus comprising:
a PLC interface which is connected to a power line; and
a control unit which controls signal output by the PLC interface,
wherein the control unit effects transition to a hibernate state in which the signal output from the PLC interface is stopped, in accordance with a fact that a state in which transmission data that is transmitted to the PLC interface and reception data that is received via the PLC interface are absent continues over a predetermined hibernation determination period, and
the control unit effects transition to a normal working state in which the signal output from the PLC interface is executed, in accordance with a fact that in the hibernate state an amount of to-be-transmitted data to the PLC interface exceeds a predetermined startup threshold or reception of a startup signal by the PLC interface is detected, and the control unit causes the PLC interface to output the startup signal in a case where transition is effected to the normal working state in accordance with the exceeding of the startup threshold.

2. The power line communication apparatus according to claim 1, wherein the startup signal includes ID information which is capable of uniquely identifying a communication counterpart apparatus, and
the control unit detects the reception of the startup signal by the PLC interface, on the basis of a collation result between the identification information and collation information for identifying the own apparatus.

3. The power line communication apparatus according to claim 1, wherein the control unit effects transition from the hibernate state to the normal working state in accordance with a startup instruction which is input from outside, and causes the PLC interface to output the startup signal.

4. The power line communication apparatus according to claim 3, wherein the startup instruction includes apparatus designation information which designates the communication counterpart apparatus, and
the control unit causes the PLC interface to output the startup signal including the ID information which is determined on the basis of the apparatus designation information.

5. The power line communication apparatus according to claim 1, further comprising:
a LAN interface; and
a transmission data buffer which stores the transmission data which is relayed between the LAN interface and the PLC interface,
wherein the control unit determines transition from the hibernate state to the normal working state by comparing an amount of data stored in the transmission data buffer and the startup threshold.

6. The power line communication apparatus according to claim 4, wherein the control unit executes determination of absence of the transmission data and the reception data, by referring to a transmission/reception history of the LAN interface.

7. A control method of a power line communication apparatus, comprising:
monitoring presence/absence of transmission data which is transmitted to a PLC interface that is connected to a power line and reception data which is received via the PLC interface;
effecting transition to a hibernate state in which signal output from the PLC interface is stopped, in accordance with a fact that a state in which the transmission data and the reception data are absent continues over a predetermined hibernation determination period;
effecting transition to a normal working state in which the signal output from the PLC interface is executed, in accordance with a fact that in the hibernate state an amount of to-be-transmitted data to the PLC interface has exceeded a predetermined startup threshold or reception of a startup signal by the PLC interface has been detected; and
causing the PLC interface to output the startup signal in a case where transition is effected to the normal working state in accordance with the exceeding of the startup threshold.

8. The method according to claim 7, wherein the amount of to-be-transmitted data is an amount of data that is stored in a transmission data buffer which stores the transmission data which is relayed between a LAN interface and the PLC interface, and
transition from the hibernate state to the normal working state is determined by comparing the amount of data stored in the transmission data buffer and the startup threshold.

9. A power line communication system comprising a first communication apparatus and a second communication apparatus,
wherein the first communication apparatus includes:
a first PLC interface which is connected to a power line; and
a first control unit which effects transition to a normal working state in which signal output from the first PLC interface is executed, and causes the first PLC interface to output a startup signal, in accordance with a fact that in a hibernate state in which the signal output from the first PLC interface is stopped, an amount of to-be-transmitted data to the first PLC interface has exceeded a predetermined startup threshold, and
the second communication apparatus includes:
a second PLC interface which is connected to the power line; and
a second control unit which effects transition to a normal working state in which signal output from the second PLC interface is executed, in accordance with a fact that in a hibernate state in which the signal output from the second PLC interface is stopped, reception of the startup signal by the second PLC interface has been detected.
